(19) United States
(12) Patent Application Publication
(10) Pub. No.: US 2008/0096607 A1
(43) Pub. Date: Apr. 24, 2008

(54) PACKET SERVICE ATTACHING APPARATUS AND METHOD IN MOBILE COMMUNICATION TERMINAL

(75) Inventor: Yong-Noh Lee, Cheonan-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/871,637

(22) Filed: Oct. 12, 2007

(30) Foreign Application Priority Data
Oct. 23, 2006 (KR) 2006-0102841

(51) Int. Cl. H04B 1/38

(52) U.S. Cl. 455/558

(57) ABSTRACT

Packet service attaching apparatus and method of a mobile communication terminal are provided. The packet service attaching apparatus includes a communication part for transmitting an Attach Request message to access a Public Land Mobile Network (PLMN), receiving an Attach Accept message or an Attach Reject message, and transmitting and receiving packet data in the packet service; a message generation part for generating the Attach Request message; and a packet service part for controlling the transmission of the Attach Request message generated at the message generation part to a corresponding PLMN through the communication part, and to retransmit the Attach Request message at preset intervals when the Attach Reject message is received from the corresponding PLMN.

### PRIORITY

This application claims priority under 35 U.S.C. §119 to an application filed in the Korean Intellectual Property Office on Oct. 23, 2006 entitled “Packet Service Attaching Apparatus and Method in Mobile Communication Terminal” and assigned Serial No. 2006-102841, the contents of which are incorporated herein by reference.

### BACKGROUND OF THE INVENTION

1. Field of the Invention

The present invention relates generally to a packet service attaching apparatus and method in a mobile communication terminal, and in particular, to a packet service attaching apparatus and method of a mobile communication terminal which reattempt a network access for a preset number of times at preset intervals even if the access rejection is due to network failure when the mobile communication terminal attempts to access the network to provide a packet service.

2. Description of the Related Art

Typically, a mobile communication system refers to voice or data services over a wireless network. Particularly, with the popularization of mobile communication terminals, network configuration of the mobile communication system requires the ability of more efficiently transmitting voice and data. As the amount of the transmitted data tends to increase with the various services, a General Packet Radio Service (GPRS) advanced from the existing circuit switching Global System for Mobile Communications (GSM) network was developed. In the packet data service such as GPRS, a user's primary purpose is to utilize the existing Internet such as file transfer at wireless PC, transmission and reception of e-mails, and Internet search via World Wide Web (WWW).

To provide the packet service, the mobile communication terminal needs to access the GPRS network. The access of the mobile communication terminal to the GPRS network is briefly illustrated in FIGS. 1A and 1B.

FIGS. 1A and 1B depict network access processes of the mobile communication terminal for the packet service in the related art.

FIG. 1A is a case where the access to the network is successful. A mobile communication terminal 100 sends an Attach Request message 120, which requests the network access for the packet service, to a network 110. Upon receiving an Attach Accept message 122 allowing the access from network 120, mobile communication terminal 100 commences packet service 130.

By contrast, FIG. 1B is a case where the access to the network fails. After sending an Attach Request message 120 requesting the network access for the packet service to network 110, mobile communication terminal 100 receives an Attach Reject message 124 informing of the access failure from network 110.

Receiving Attach Reject message 124, mobile communication terminal 100 can acquire a failure cause from Attach Reject message 124.

When Attach Reject message 124 is received as in FIG. 1B and the rejection cause for the access request is “GPRS services not allowed in this PLMN” which implies the access is rejected because the GPRS service is not supported because of the network failure, the mobile communication terminal classifies the corresponding Public Land Mobile Network (PLMN) to the list of the forbidden PLMNs for GPRS services and manages it as described in the standard 3^{rd} Generation Partnership Project (3GPP) specification 24.088 4.7.1.8.

Even if the access failure to the network included to the list of the forbidden PLMNs for GPRS services is solved and its network access normally works, the mobile communication terminal cannot know this situation. Thus, the packet service cannot be provided until the mobile communication terminal is turned on and off or a Subscriber Identity Module (SIM) is removed and inserted again.

Meanwhile, the access rejection due to “GPRS services not allowed in this PLM” may happen when the corresponding network cannot support the GPRS service in practice and also when a temporary failure occurs. In the latter case, since the mobile communication terminal is not able to tell the temporary access failure, the packet service is not available until the mobile communication terminal is turned on and off or the SIM is removed and inserted again in spite of the temporary access failure.

### SUMMARY OF THE INVENTION

An object of the present invention is to solve at least the above problems and/or disadvantages and to provide at least the advantages below. Accordingly, an aspect of the present invention is to provide a packet service attaching apparatus and method of a mobile communication terminal.

Another aspect of the present invention is to provide a packet service attaching apparatus and method of a mobile communication terminal, which reattempts the network access at preset intervals to provide a packet service even when the access is rejected due to the network failure. 100141 A further aspect of the present invention is to provide a packet service attaching apparatus and method of a mobile communication terminal, which reattempts the network access for a preset number of times at preset intervals to provide a packet service even when the access is rejected due to the network failure.

The above aspects are achieved by providing a packet service attaching apparatus of a mobile communication terminal, which includes a communication part for transmitting an Attach Request message to access a Public Land Mobile Network (PLMN), receiving an Attach Accept message or an Attach Reject message, and transmitting and receiving packet data in the packet service; a message generation part for generating the Attach Request message; and a packet service part for controlling to transmit the Attach Request message generated at the message generation part to a corresponding PLMN through the communication part, and to retransmit the Attach Request message at preset intervals when the Attach Reject message is received from the corresponding PLMN.

According to one aspect of the present invention, a packet service attaching method of a mobile communication terminal includes generating and transmitting an Attach Request message to a corresponding PLMN; and retransmitting the Attach Request message at preset intervals when an Attach Reject message is received from the corresponding PLMN.

### BRIEF DESCRIPTION OF THE DRAWINGS

The above and other objects, features and advantages of the present invention will become more apparent from the following detailed description when taken in conjunction with the accompanying drawings in which:

FIGS. 1A and 1B depict network access processes of a mobile communication terminal for packet service in the related art;

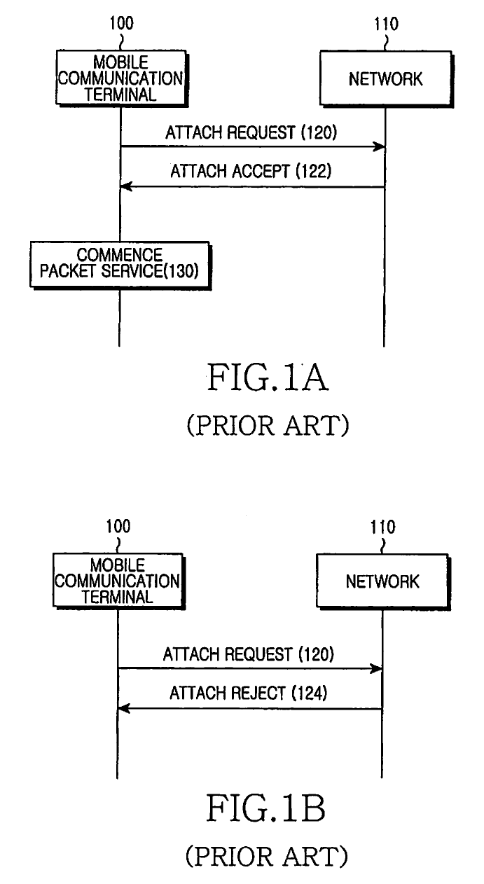

FIG. 2 is a block diagram of a packet service attaching apparatus of a mobile communication terminal according to the present invention; and

FIG. 3 is a flowchart of a network access procedure of the mobile communication terminal for the packet service according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides a packet service attaching apparatus and method for a mobile communication terminal, which reattempts the network access for a preset number of times at preset intervals to provide a packet service even when the access is rejected due to the network failure.

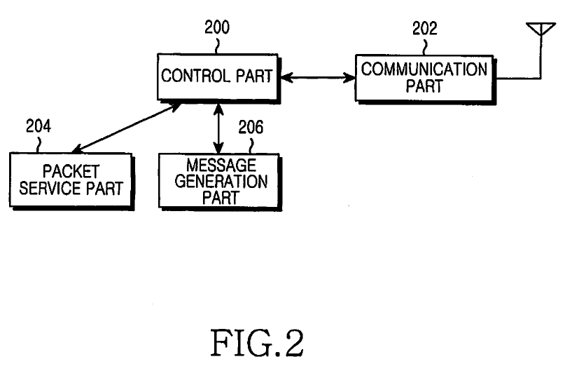

FIG. 2 is a block diagram of a packet service attaching apparatus of a mobile communication terminal according to the present invention. The mobile communication terminal of FIG. 2 includes a control part 200, a communication part 202, a packet service part 204, and a message generation part 206.

Communication part 202 serves to transmit and receive voice signal and packet data. In the reception, communication part 202 despreads and decodes a received signal by down-converting the radio frequency signal received. In the transmission, communication part 202 codes, spreads, up-converts, and then transmits the signal.

Packet service part 204 generates an Attach Request message at message generation part 206 and transmits the Attach Request message to a GPRS network through communication part 202 to provide a packet service. When receiving an Attach Accept message through communication part 202, packet service part 204 commences the packet service.

However, when receiving an Attach Reject message with the cause of “GPRS services not allowed in this PLMN” implying the corresponding PLMN does not support the GPRS service, packet service part 204 attempts to access the network by retransmitting the Attach Request message until the Attach Reject message is received for a preset number of times at preset intervals in succession.

After receiving the Attach Reject messages for a preset number of times in succession, packet service part 204 determines the corresponding PLMN does not practically support the packet service, classifies the communication network of the aborted packet service to a list of forbidden PLMNs for GPRS services, and then terminates the access trial.

Message generation part 206 generates the Attach Request message requesting the access to the network for the packet service according to the request of packet service part 204.

Control part 200 controls packet service part 204 and message generation part 206. That is, control part 200 can function as packet service part 204 and message generation part 206. According to the present invention, they are separately provided and illustrated to distinguish their respective functions. Hence, in the actual implementation, both or part of packet service part 204 and message generation part 206 can be processed at control part 200.

Now, a packet service attaching method of the mobile communication terminal constructed above is described by referring to the drawing.

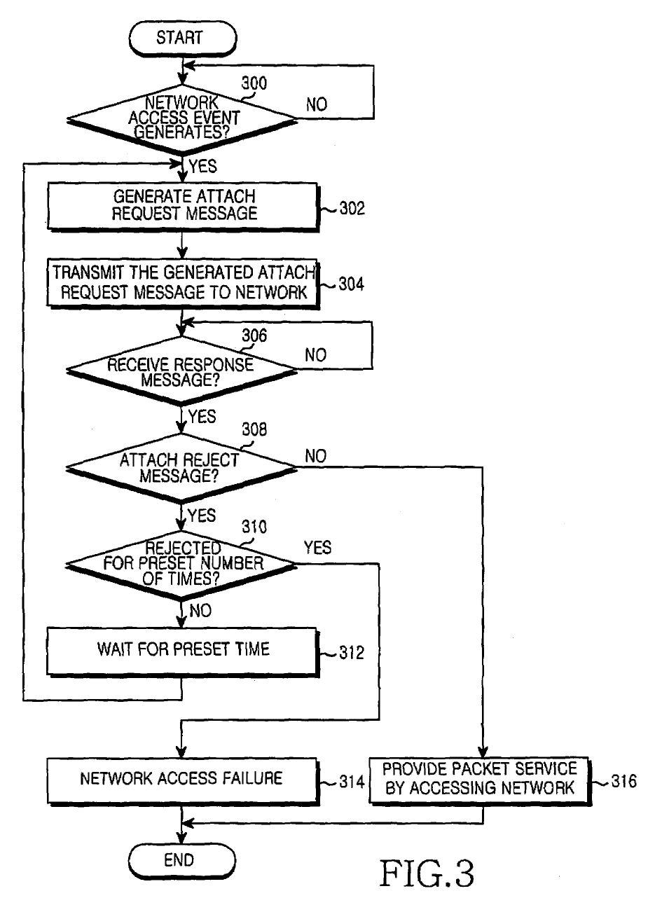

Referring to FIG. 3, when detecting the generation of the network access event in step 300, the mobile communication terminal generates the Attach Request message for requesting the access to the network in step 302 and transmits the generated Attach Request message to the corresponding PLMN in step 304. When receiving a response message in step 306, the mobile communication terminal checks whether the received response message is an Attach Reject message with the cause of “GPRS services not allowed in this PLMN” implying the unsupported GPRS service in step 308.

When the received response message is not the Attach Reject message but an Attach Accept message in step 308, the mobile communication terminal provides the packet service by accessing the corresponding PLMN in step 316.

When the received response message is the Attach Reject message in step 308, the mobile communication terminal checks whether the Attach Reject message has been received over a preset number of times in succession from the corresponding PLMN in step 310.

When the Attach Reject message is not received for the preset number of times in step 310, the mobile communication terminal waits for a preset time in step 312 and then returns to step 302.

When the Attach Reject message is received for the preset number of times in step 310, the mobile communication terminal determines the corresponding PLMN does not practically support the packet service in step 314, classifies it to the list of the forbidden PLMNs for GPRS services, and then terminates the access trial.

As set forth above, in the packet service attaching apparatus and method, the mobile communication terminal retries the network access for a preset number of times at the preset intervals for the packet service even when the access is rejected because of network failure. Therefore, when the network access rejection results from the temporary failure, the mobile communication terminal can access the network again.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A packet service attaching apparatus for a mobile communication terminal, comprising:
a communication part for transmitting an Attach Request message to access a Public Land Mobile Network (PLMN), receiving an Attach Accept message or an Attach Reject message, and transmitting and receiving packet data in the packet service;
a message generation part for generating the Attach Request message; and
a packet service part for controlling the transmission of the Attach Request message generated at the message generation part to a corresponding PLMN through the communication part, and to retransmit the Attach Request message at preset intervals when the Attach Reject message is received from the corresponding PLMN.

2. The packet service attaching apparatus of claim 1, wherein the packet service part aborts the retransmission of the Attach Request message when the Attach Reject message is received from the corresponding PLMN for a preset number of times in succession.

3. The packet service attaching apparatus of claim 2, wherein, when the Attach Reject message is received from the corresponding PLMN for the preset number of times in succession, the packet service part determines the corresponding PLMN does not practically support the packet service, and classifies it to a list of forbidden PLMNs for GPRS services.

4. The packet service attaching apparatus of claim 3, wherein the Attach Reject message implies the cause of the access rejection is that the corresponding PLMN does not support the packet service.

5. The packet service attaching apparatus of claim 2, wherein, when the Attach Accept message is received, the packet service part initializes the preset number of times being counted and provides the packet service by accessing the corresponding PLMN.

6. A packet service attaching method of a mobile communication terminal, the method comprising:
generating and transmitting an Attach Request message to a corresponding Public Land Mobile Network (PLMN); and
retransmitting the Attach Request message at preset intervals when an Attach Reject message is received from the corresponding PLMN.

7. The packet service attaching method of claim 6, wherein the retransmission of the Attach Request message is aborted when the Attach Reject message is received from the corresponding PLMN for a preset number of times in succession.

8. The packet service attaching method of claim 7, wherein, when the Attach Reject message is received from the corresponding PLMN for the preset number of times in succession, the packet service part determines that the corresponding PLMN does not practically support the packet service and classifies it to a list of forbidden PLMNs for GPRS services.

9. The packet service attaching method of claim 8, wherein the Attach Reject message implies the cause of the access rejection is that the corresponding PLMN does not support the packet service.

10. The packet service attaching method of claim 6, after generating and transmitting the Attach Request message to the corresponding PLMN, further comprising:
initializing the preset number of times being counted when the Attach Accept message is received; and
providing the packet service by accessing the corresponding PLMN.

11. A packet service attaching apparatus of a mobile communication terminal, the apparatus comprising:
means for generating and transmitting an Attach Request message to a corresponding Public Land Mobile Network (PLMN); and
means for retransmitting the Attach Request message at preset intervals when an Attach Reject message is received from the corresponding PLMN.

12. The apparatus of claim 11, wherein the retransmission of the Attach Request message is aborted when the Attach Reject message is received from the corresponding PLMN for a preset number of times in succession.

13. The apparatus of claim 11, after means for generating and transmitting the Attach Request message to the corresponding PLMN, further comprising:
means for initializing the preset number of times being counted when the Attach Accept message is received; and
means for providing the packet service by accessing the corresponding PLMN.

14. A computer-readable recording medium having recorded thereon a program for packet service attaching in a mobile communication terminal, comprising:
a first code, for generating and transmitting an Attach Request message to a corresponding Public Land Mobile Network (PLMN); and
a second code, for retransmitting the Attach Request message at preset intervals when an Attach Reject message is received from the corresponding PLMN.
